(19) United States
(12) Patent Application Publication
(10) Pub. No.: US 2026/0038508 A1
(43) Pub. Date: Feb. 5, 2026

(54) CONSISTENCY CHECK FOR LARGE LANGUAGE MODEL CONTINUOUS CONVERSATIONS

(71) Applicant: Samsung Electronics Co., Ltd., Suwon-si, (KR)

(72) Inventors: Haoran Wei, San Jose, CA (US); Srinivasa Rao Ponakala, Sunnyvale, CA (US); Neha Barde, Mountain View, CA (US); Gowtham Srinivasan, San Jose, CA (US); Patrick Hegarty, San Francisco, CA (US); Taeyeon Ki, Milpitas, CA (US); Kenneth Youngjin Cho, San Francisco, CA (US); Vijendra Raj Apsingekar, San Jose, CA (US)

(21) Appl. No.: 18/970,600

(22) Filed: Dec. 5, 2024

Related U.S. Application Data
(60) Provisional application No. 63/677,750, filed on Jul. 31, 2024.

(51) Int. Cl. G10L 17/06; G10L 17/02; G10L 17/22

(52) U.S. Cl. CPC G10L 17/06; G10L 17/02; G10L 17/22

(57) ABSTRACT

In addition to speaker verification, an LLM continuous conversation check employs a spoken speed check using a phonemes-based spoken speed calculation, and acoustic energy check, and a signal-to-noise estimation to determine whether first and second audio inputs include utterances forming a continuous conversation by the user with the LLM. Results from the various components of the continuous conversation check are fused based on automatically assigned weights in making the determination. Continuous conversation detection for LLMs is therefore more robust, particularly for a very short second utterance. Optionally a distance to microphone check or a semantic consistency check may also be employed.

### CROSS-REFERENCE TO RELATED APPLICATIONS AND PRIORITY CLAIM

This application claims priority under 35 U.S.C. § 119(e) to U.S. Provisional Patent Application No. 63/677,750 filed on Jul. 31, 2024, which is hereby incorporated by reference in its entirety.

### TECHNICAL FIELD

This disclosure relates generally to audio input signal processing. More specifically, this disclosure relates to continuous conversation detection for speech-based natural language processing (NLP).

### BACKGROUND

Large language model (LLM) voice assistants may implement “continuous conversation” detection, in which the user's utterance following a response to an initial user inquiry is identified as a continuation of the initial inquiry. At least three issues can arise: First, where speaker (identity) verification is employed, the speaker verification model may generate a low similarity score for very short following utterances (for example, user say ‘yes’), leading to a wrong prediction. Second, even when both utterances come from the same speaker, the second utterance may not target the voice assistant when, for example, the user is speaking to other people during the microphone open period. In such cases, a wrong message will be sent to the voice assistant. Third, in a high background noise scenario, the audio energy value mostly depends on the noise level, not user speech, such that only comparing audio energy cannot achieve a good performance.

### SUMMARY

This disclosure relates to detecting continuous conversations with an AI assistant.

In a first embodiment, an electronic device includes a microphone, at least one processing device, and at least one memory in communication with the processor. The memory stores a speaker consistency check module configured to perform a speaker verification and a check spoken speed, an acoustic consistency check module configured to perform an audio energy check and a signal-to-noise ratio (SNR) estimation, and a result fusion module. The memory further stores instructions that, when executed, cause the processor to receive a first user utterance after a wake-up word for an artificial intelligence (AI) assistant. The instructions, when executed, also cause the processor to feed the first user utterance to the speaker consistency check module and the acoustic consistency check module. The instructions, when executed, further cause the processor to save first outputs from the speaker consistency check module and the acoustic consistency check module. The instructions, when executed, still further cause the processor to receive a second user utterance after the first user utterance within a selected period of time. The instructions, when executed, cause the processor to feed the second user utterance to the speaker consistency check module and the acoustic consistency check module. The instructions, when executed, cause the processor to provide the first outputs from the speaker consistency check module and the acoustic consistency check module and second outputs from the speaker consistency check module and the acoustic consistency check module to the result fusion module to generate a result. The instructions, when executed, cause the processor to determine whether the second user utterance is intended for the AI assistant, based at least in part on the result from the result fusion module.

In a second embodiment, a method includes receiving a first user utterance after a wake-up word for an artificial intelligence (AI) assistant. The method also includes feeding the first user utterance to the speaker consistency check module configured to perform a speaker verification and a check spoken speed and to an acoustic consistency check module configured to perform an audio energy check and a signal-to-noise ratio (SNR) estimation. The method further includes saving first outputs from the speaker consistency check module and the acoustic consistency check module. The method still further includes receiving a second user utterance after the first user utterance within a selected period of time. The method includes feeding the second user utterance to the speaker consistency check module and the acoustic consistency check module. The method includes providing the first outputs from the speaker consistency check module and the acoustic consistency check module and second outputs from the speaker consistency check module and the acoustic consistency check module to a results fusion module to generate a result. The method includes determining whether the second user utterance is intended for the AI assistant, based at least in part on the result from the result fusion module.

In a third embodiment, a non-transitory machine readable medium includes instructions that when executed cause at least one processor of an electronic device to receive a first user utterance after a wake-up word for an artificial intelligence (AI) assistant. The instructions when executed also cause the at least one processor of the electronic device to feed the first user utterance to the speaker consistency check module configured to perform a speaker verification and a check spoken speed and to an acoustic consistency check module configured to perform an audio energy check and a signal-to-noise ratio (SNR) estimation. The instructions when executed further cause the at least one processor of the electronic device to save first outputs from the speaker consistency check module and the acoustic consistency check module. The instructions when executed still further cause the at least one processor of the electronic device to receive a second user utterance after the first user utterance within a selected period of time. The instructions when executed cause the at least one processor of the electronic device to feed the second user utterance to the speaker consistency check module and the acoustic consistency check module. The instructions when executed cause the at least one processor of the electronic device to provide the first outputs from the speaker consistency check module and the acoustic consistency check module and second outputs from the speaker consistency check module and the acoustic consistency check module to a results fusion module to generate a result. The instructions when executed cause the at least one processor of the electronic device to determine whether the second user utterance is intended for the AI assistant, based at least in part on the result from the result fusion module.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration which may be employed in conjunction with consistency checks for LLM continuous conversations in accordance with this disclosure;

FIG. 2 illustrates an example process of implementing a consistency check for LLM continuous conversations in accordance with this disclosure;

FIG. 3 illustrates an example architecture for consistency checks for LLM continuous conversations in accordance with this disclosure;

FIG. 4 illustrates in greater detail one embodiment for the spoken speed check in FIG. 3; and

FIG. 5 illustrates an alternative example architecture for consistency checks for LLM continuous conversations in accordance with this disclosure.

### DETAILED DESCRIPTION

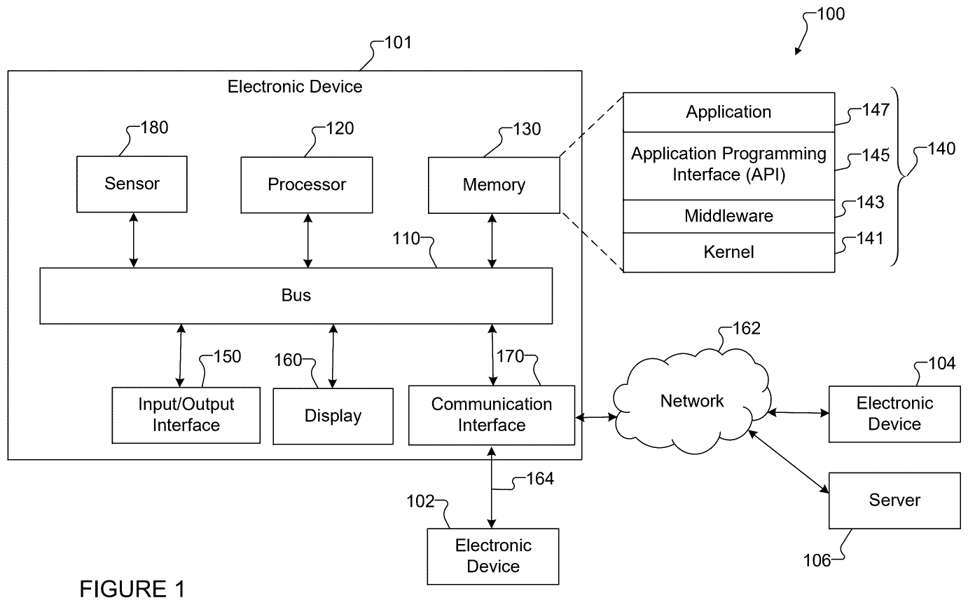

FIGS. 1 through 5, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

FIG. 1 illustrates an example network configuration which may be employed in conjunction with consistency checks for LLM continuous conversations in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to consistency checks for LLM continuous conversations.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to consistency checks for LLM continuous conversations. For example, the application 147 may include a voice assistant function. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, which include one or more imaging sensors, or a VR or XR headset.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to consistency checks for LLM continuous conversations.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

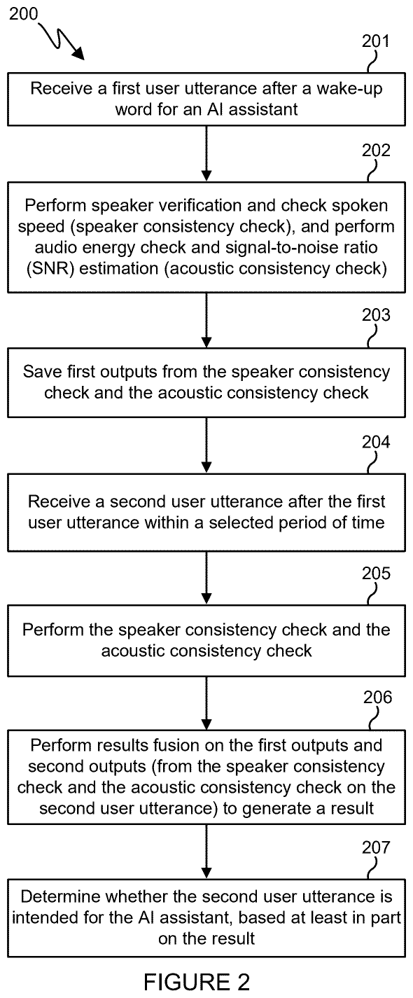

FIG. 2 illustrates an example process 200 of implementing a consistency check for LLM continuous conversations in accordance with this disclosure. For ease of explanation, the process 200 of FIG. 2 is described as being performed using the electronic device 101 in the network configuration 100 of FIG. 1. However, the process 200 may be performed using any other suitable device(s) and in any other suitable system(s).

As shown in FIG. 2, the process 200 starts with receiving a first user utterance after a wake-up word for an AI assistant (step 201). The utterance is included within an audio input captured by the microphone of an electronic device 101. Speaker verification is performed and spoken speed of the utterance is checked as part of a speaker consistency check, and an audio energy check and signal-to-noise (SNR) estimation are performed as part of an acoustic consistency check (step 202). The speaker consistency check for the first utterance provides characteristics (pitch, speaking speed, etc.) of user speech that will be used as a basis for comparison with comparable characteristics for a subsequent utterance. The acoustic consistency check for the first utterance provides characteristics (loudness, clarity, etc.) of the utterance that will also be used as a basis for comparison with corresponding characteristics for the same subsequent utterance. The outputs from the speaker consistency check and the acoustic consistency check are saved (step 203). As noted, those outputs will be the basis for comparison with any subsequent utterance. A second utterance is received, also included within audio input captured by the microphone of an electronic device 101, within a selected period of time after the first utterance (step 204). A speaker consistency check (speaker verification and spoken speed check) and an acoustic consistency check (audio energy check and SNR estimation) are performed on the second utterance (step 205), to produce second outputs. The second outputs may optionally be saved. Results fusion is performed on the first outputs and the second outputs, to generate a result (step 206). The results fusion involves a weighted combination of the outputs from various models (at least speaker verification, spoken speed check, audio energy check, and SNR estimation in the example being described). Based at least in part on the output of results fusion, a determination is made as to whether the second user utterance is intended for the AI assistant (step 207). If the second utterance is intended for the AI assistant, the utterance is passed to the AI assistant as part of a continuous conversation with the first utterance.

Although FIG. 2 illustrates one example of implementing a consistency check for LLM continuous conversations, various changes may be made to FIG. 2. For example, while shown as a series of steps, various steps in FIG. 2 could overlap, occur in parallel, occur in a different order, or occur any number of times (including zero times).

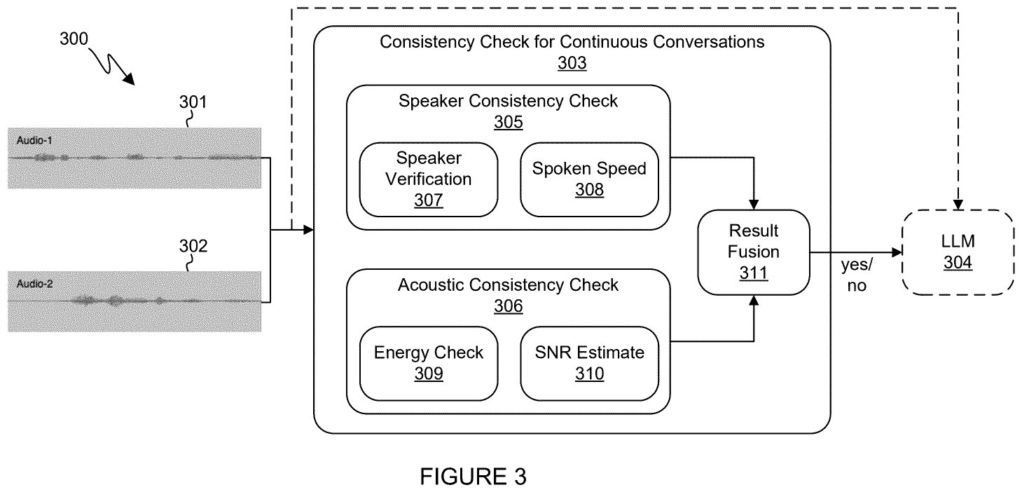

FIG. 3 illustrates an example architecture 300 for consistency checks for LLM continuous conversations in accordance with this disclosure. For case of explanation, the architecture 300 of FIG. 3 is described as being used by the electronic device 101 in the network configuration 100 of FIG. 1. However, the architecture 300 may be used by any other suitable device(s) and in any other suitable system(s).

As shown in FIG. 3, the architecture 300 receives a first audio input 301 and a second audio input 302. The second audio input 302 is separate from the first audio input 301, at least separate in time and possibly also separated by an output from a voice assistant. For example, the microphone (e.g., sensor 180) employed for a voice assistant (e.g., application 147) may be opened for following provision of a response to the user's initial spoken inquiry for a few seconds (e.g., 7 second) to listen to the user's following utterance. The first audio input 301 may include the user's initial spoken query inquiry, and the second audio input 302 may include the user's subsequent utterance.

The first audio input 301 and the second audio input 302 are received by a trained consistency check model 303 performing consistency checks for continuous conversations. The consistency check model 303 provides multiple checks. In the example illustrated, the consistency check model 303 performs a speaker consistency check 305 and an acoustic consistency check 306. Specifically, speaker consistency check 305 performs a speaker consistency checks based on speaker verification and spoken speed, while acoustic consistency check 306 performs an acoustic consistency check based on energy and signal-to-noise ratio (SNR). The continuous conversation consistency check uses a speaker verification check 305 to check the consistency between the user-spoken utterances to allow the user to employ the continuous conversation function of an LLM 304 that accepts voice input (e.g., a voice assistant).

In general, the speaker consistency check 305 within the continuous conversation function uses the first user-spoken utterance in audio input 301 as a register spoken utterance in order to generate a speaker embedding for speaker verification 307. After the user has spoken the first utterance, the LLM 304 will answer the user and then open the microphone for several seconds, waiting for user's following utterances (if any) in audio input 302. If audio input 302 contains an utterance by the same speaker as the utterance in audio input 301, audio input 302 is inferred to be part of a continuous conversation that was begun with audio input 301. Any following utterance—that is, subsequent to the second utterance—in a continuous conversation also goes through the speaker verification 307 to obtain a speaker embedding to assess speaker similarity. Speaker embeddings generated by the first utterance and the second (or following) utterance may be compared by cosine similarity. A predefined threshold is used to predict if the audio input 302 is an utterance directed to the voice assistant.

In addition to checking the user's pronunciation (timbre, etc.) features from speaker verification 307, speaker consistency check 305 also performs a spoken speed check 308 of the user. Spoken speed check 308 improves the accuracy of the speaker consistency check 305, especially for short-duration user speech. For example, the spoken speed check 308 may utilize automatic speech recognition (ASR) transcription, a force alignment model, and a lexicon dictionary. Additional details for the spoken speed check 308 are provide below.

In general, the acoustic consistency check 306 within the continuous conversation function uses energy check 309 to compare acoustic energy of the audio input 302 to the audio input 301, and SNR estimate check 310 to compare SNRs of the two audio inputs. One or both of energy check 309 and SNR estimate check 310 may indicate speaker distance from the microphone of the electronic device 101, which is suggestive of whether the user intended the second utterance for the voice assistant. If the user wants to speak with others, they may turn their head in another direction, or perhaps put the phone down, which behaviors generate a difference in audio energy. Audio energy is calculated from each of audio input 301 and audio input 302 individually, then the energy difference is calculated between the registered audio (audio input 301) and the following audio (audio input 302). A threshold is applied to check if the following audio is intended for the voice assistant. Audio energy may be calculated with Python toolkits—for example, pydub can obtain the digital audio energy in decibels (dB). Alternatively, audio energy may be represented by root mean square (RMS) from audio samples, which does not rely on toolkits and makes for casy deployment. SNR measures the level of a desired signal to the level of background noise and may be calculated using different formulas depending on how the signal and noise are measured and defined. One most common SNR calculation is SNR=10×log (signal power/noise power) for digital audio signals. Audio SNR calculations need two audio resources, one from the target user and the other from background noise (i.e., electronic device 101 may employ two microphones in oriented in different directions). If only have one audio contains both user speech and background noise, SNR needs to be estimated by algorithm. Waveform Amplitude Distribution Analysis (WADASNR) is a method for estimating SNR from a single audio input based on assumptions: that the speech signal and the noise signal are independent; that clean speech follows a gamma distribution with a fixed shaping parameter between 0.4 to 0.5; and that the background noise has a Gaussian distribution.

The outputs for speaker consistency check 305 and acoustic consistency check 306 are input to result fusion 311. A decision-level model fusion approach is employed to automatically give weight to each model, and then generate the final decision. Even if any model's result is missing, this approach is still able to work. The outputs from different models are utilized together to make the final prediction, to determine if the second audio input 302 is targeting the voice assistant. A basic decision-level fusion can be achieved by the grid search method. A validation dataset needs to be utilized to determine the parameters for each model. Given a weight for each model, the final decision is calculated based on the weighted score. For example, suppose there are independent models, each model output will be normalized to 0 to 1, and then the parameters a, b, c, and d will be determined based on a grid search using a validation dataset:

$$\begin{matrix}Final Score = a * Model\_ 1 \_score + b * Model\_ 2 \_score + c * Model\_ 3 \_score + d \\ * Model\_ 4 \_score .\end{matrix}$$

The sum of a, b, c, and d should be 1. A cross-validation can be utilized to test the performance of the final prediction. Every 20% of data from the test set will be split as the validation set to generate the parameters, and the remaining 80% of the data will be used to test the performance. Five-round cross-validation is performed to get the final output results.

Although FIG. 3 illustrates one example of an architecture 300 for consistency checks for LLM continuous conversations, various changes may be made to FIG. 3. For example, other checks may be performed as part of the consistency checks in alternative embodiments. Examples of such additional checks are described below.

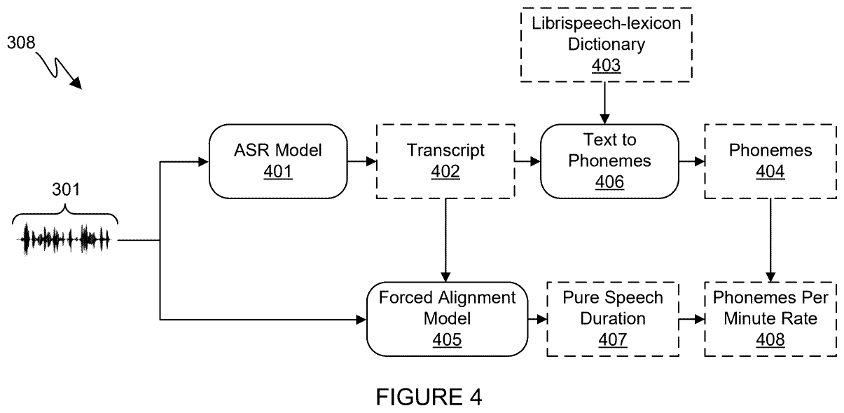

FIG. 4 illustrates in greater detail one embodiment for the spoken speed check 308 in FIG. 3 in accordance with this disclosure. The spoken speed check 308 is shown as receiving audio input 301. However, those skilled in the art will understand that the spoken speed check 308 will also receive and process audio input 302.

Spoken speed check 308 performs a phonemes-based spoken speed calculation to obtain robust spoken speed results. Typical spoken speed for English is around 110-150 words per minute, but some individuals speak as fast as 250 words per minute. At the same time, word-based spoken speed calculation depends on the content of words, with words having a large range in the number of phonemes that makes only counting for words per minute inaccurate. For example, the word ‘NO’ has 2 phonemes of ‘N OW1’, while the word ‘MULTIFARIOUSNESS’ has 14 phonemes of ‘M AH2 L T IY0 F EH1 R IY0 AH0 SN AH0 S’

The audio input 301 utilizes an ASR model 401 to obtain a transcript 402 of the speech within the audio, an ASR lexicon dictionary 403 as part of converting the word level transcript 402 to phonemes 404, and a forced alignment model 405 in obtaining the actual user speech duration. The audio input 301 is received by ASR model 401, which generates a transcript in accordance with the known art. Text to phonemes conversion 406 is performed using the transcript 402 and a lexicon dictionary 403 to produce a list of the phonemes 404 for any utterance detected within the audio input 301. Various alternatives may also be employed.

To calculate the spoken speed in phonemes per minute, the forced alignment model 405 operates on the audio input 301 and the transcript 402. Forced alignment employs an orthographic transcription of audio and generates a time-aligned version thereof using a pronunciation dictionary to look up phonemes for the transcribed words. The output of the forced alignment model 405 is a pure speech duration 407 corresponding to the total period(s) of utterance(s) within the audio input 301 (i.e., excluding noise). The list of phonemes 404 and the speech duration 407 may then be employed to derive an average phonemes per minute rate 408 for the utterance(s) within the audio input 301. The spoken speed check 308 for audio input 301 is used to establish a reference, to which a spoken speed check 308 for a subsequent audio input 302 is compared as part of ascertaining speaker consistency.

Although FIG. 4 illustrates one example of a spoken speed check 308, various changes may be made to FIG. 4. For example, various blocks may be combined or interconnected so that pipelined or real time performance is improved.

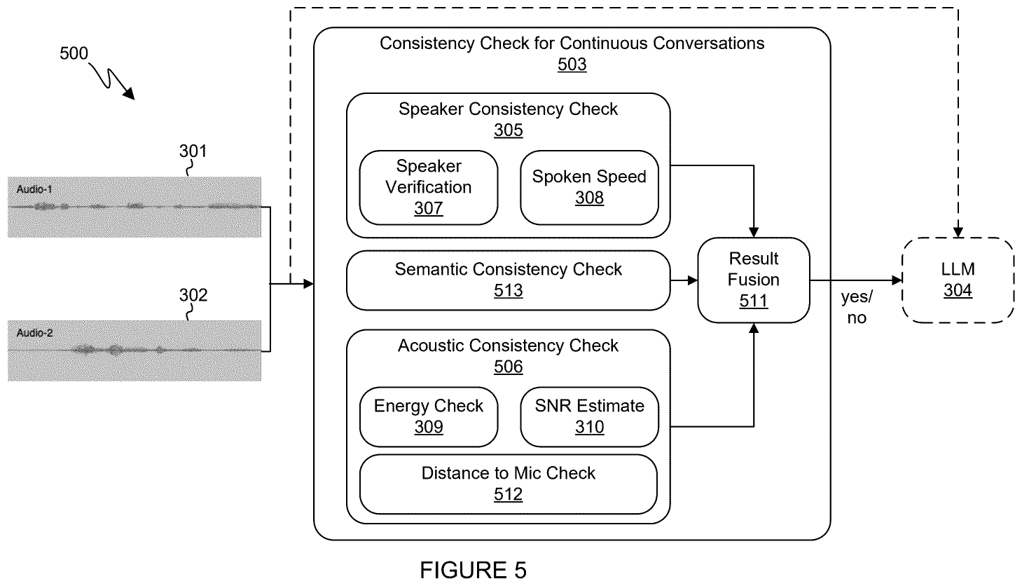

FIG. 5 illustrates an alternative example architecture 500 for consistency checks for LLM continuous conversations in accordance with this disclosure. For ease of explanation, the architecture 500 of FIG. 5 is described as being used by the electronic device 101 in the network configuration 100 of FIG. 1. However, the architecture 500 may be used by any other suitable device(s) and in any other suitable system(s).

The architecture 500 is similar to architecture 300 in many respects, and detailed description of identical functionality such as the speaker consistency check 305, the energy check 309, and the SNR estimate check 310 will not be repeated. The acoustic consistency check 506, however, differs from the counterpart in FIG. 3 by adding a distance to microphone check 512. A prediction of the speaker distance from the microphone of the electronic device 101 may help to check the acoustic consistency between audio input 301 and audio input 302, as the user may not move a long distance from the microphone during the conversation with the voice assistant. The model for the distance to microphone check 512 can be implemented by commonly used audio features and deep learning models, such as those performing sound source distance estimation or sound source localization. There are also specifically defined audio features to deal with this issue, including but not limited to those employing metrics characterizing the distribution and characteristics of signal energy with a focus on identifying irregularities or deviations from a typical pattern, often by examining the residual signal after applying a linear prediction model (e.g., linear prediction residual peaks, linear prediction residual kurtosis, skewness of spectrum, and skewness of energy differences). In the architecture 500 of FIG. 5, the output of the acoustic consistency check 506 therefore takes into account a prediction of the speaker distance from the microphone.

As apparent from FIG. 5, the consistency check for continuous conversations 503 includes a third type of check: a semantic consistency check 513. Sequential utterances from the same user on the same topic are likely to have semantic similarity, including the same term for a given concept. An additional check can therefore be added to the pipeline for the consistency check for continuous conversations 503 to check semantic consistency between two utterances in a continuous conversation. One additional model can be utilized to perform the semantic consistency check 513. Alternatively, the LLM 304 may be directly used to perform this check. Because the consistency check for continuous conversations 503 includes the distance to microphone check 512 and the semantic consistency check 513, result fusion 511 must accommodate six model outputs rather than four as discussed above for result fusion 311.

To identify continuous conversations with an AI assistant, a first utterance and a second, later utterance captured during an open microphone period subsequent to an answer to the first utterance are employed. Speaker verification is performed and spoken speed is checked using the first and second utterances. Acoustic consistency between audios for the first and second user utterances is also checked, based on audio energy and SNR consistency. Results from the individual models are fused to give a final decision on whether the second utterance is part of a continuous conversation with the first utterance.

The audio consistency check for LLM-based continuous conversations tasks compares two audios from the same continuous conversations to verify that the second audio is targeting the voice assistant. The consistency check approach fuses results from at least two major aspects, speaker consistency and acoustic consistency, and optionally also semantic consistency. A decision-level model fusion approach automatically gives weight to each model, and then generate the final decision. This approach will still be able to work, even if any individual model result is missing.

In the middle of a continuous conversation, the approach described above can stop continuous conversation when the user starts talking with others. For example, if the register (initial) audio targets the voice assistant, but during the voice assistant reply and subsequent open microphone period, the user starts to talk with family members in another direction, the approach described herein will be able to reject the follow-up speech and close the continuous conversation, due to the consistency of acoustic energy and SNR. Speaker verification-only models are thus improved. The LLM therefore becomes more robust to continuous conversations. For example, if the follow-up audio from same user is very short, like ‘yes’, a speaker verification-only model will have difficulty determining that the audio is from same speaker. With the help of the spoken speed check, the acoustic energy check, and SNR check (and optionally a distance to microphone check and/or semantic check), accuracy of continuous conversation detection is improved.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. An electronic device comprising:
a microphone;
at least one processor in communication with the microphone; and
at least one memory in communication with the processor, wherein the memory stores:
a speaker consistency check module configured to perform a speaker verification and a check spoken speed;
an acoustic consistency check module configured to perform an audio energy check and a signal-to-noise ratio (SNR) estimation; and
a result fusion module,
wherein the memory further stores instructions that, when executed, cause the processor to:
receive a first user utterance after a wake-up word for an artificial intelligence (AI) assistant;
feed the first user utterance to the speaker consistency check module and the acoustic consistency check module;
save first outputs from the speaker consistency check module and the acoustic consistency check module;
receive a second user utterance after the first user utterance within a selected period of time;
feed the second user utterance to the speaker consistency check module and the acoustic consistency check module;
provide the first outputs from the speaker consistency check module and the acoustic consistency check module and second outputs from the speaker consistency check module and the acoustic consistency check module to the result fusion module to generate a result; and
determine whether the second user utterance is intended for the AI assistant, based at least in part on the result from the result fusion module.

2. The electronic device of claim 1, wherein the instructions cause the processor to provide the second user utterance to a large language model (LLM) for the AI assistant, based on the result.

3. The electronic device of claim 1, wherein the spoken speed is checked by utilizing automatic speech recognition (ASR) transcript, a force alignment model, and a lexicon dictionary.

4. The electronic device of claim 1, wherein the result fusion module is configured to automatically assign weights to the speaker consistency check module and the acoustic consistency check module.

5. The electronic device of claim 1, wherein the speaker consistency check module is configured to check spoken speed using a phonemes-based spoken speed calculation.

6. The electronic device of claim 5, wherein the phonemes-based spoken speed calculation utilizes:
an automatic speech recognition (ASR) model to obtain a word level transcript,
a lexicon dictionary to convert the word level transcript to phonemes,
a force alignment model to obtain an actual user speech duration, and
calculate a spoken speed in phonemes per minute.

7. The electronic device of claim 1,
wherein the memory further stores a semantic consistency check module, and
wherein the instructions further cause the processor to:
feed the first user utterance to the speaker consistency check module, the acoustic consistency check module, and the semantic consistency check module;
save first outputs from the speaker consistency check module, the acoustic consistency check module, and the semantic consistency check module;
feed the second user utterance to the speaker consistency check module, the acoustic consistency check module, and the semantic consistency check module; and
provide the first outputs and second outputs from the speaker consistency check module, the acoustic consistency check module, and the semantic consistency check module to the result fusion module to generate the result.

8. A method comprising:
receiving a first user utterance after a wake-up word for an artificial intelligence (AI) assistant;
feeding the first user utterance to a speaker consistency check module configured to perform a speaker verification and a check spoken speed and to an acoustic consistency check module configured to perform an audio energy check and a signal-to-noise ratio (SNR) estimation;
saving first outputs from the speaker consistency check module and the acoustic consistency check module;
receiving a second user utterance after the first user utterance within a selected period of time;
feeding the second user utterance to the speaker consistency check module and the acoustic consistency check module;
providing the first outputs from the speaker consistency check module and the acoustic consistency check module and second outputs from the speaker consistency check module and the acoustic consistency check module to a results fusion module to generate a result; and
determining whether the second user utterance is intended for the AI assistant, based at least in part on the result from the result fusion module.

9. The method of claim 8, further comprising:
providing the second user utterance to a large language model (LLM) for the AI assistant, based on the result.

10. The method of claim 8, wherein the spoken speed is checked by utilizing an automatic speech recognition (ASR) transcript, a force alignment model, and a lexicon dictionary.

11. The method of claim 8, wherein the result fusion module is configured to automatically assign weights to the speaker consistency check module and the acoustic consistency check module.

12. The method of claim 8, wherein the speaker consistency check module is configured to check spoken speed using a phonemes-based spoken speed calculation.

13. The method of claim 12, wherein the phonemes-based spoken speed calculation utilizes:
an automatic speech recognition (ASR) model to obtain a word level transcript,
a lexicon dictionary to convert the word level transcript to phonemes,
a force alignment model to obtain an actual user speech duration, and
calculate a spoken speed in phonemes per minute.

14. The method of claim 8, further comprising:
feeding the first user utterance to the acoustic consistency check module, a semantic consistency check module, and the speaker consistency check module;
saving first outputs from the speaker consistency check module, the acoustic consistency check module, and the semantic consistency check module;
feeding the second user utterance to the speaker consistency check module, the acoustic consistency check module, and the semantic consistency check module; and
providing the first outputs and second outputs from the speaker consistency check module, the acoustic consistency check module, and the semantic consistency check module to the result fusion module to generate the result.

15. A non-transitory machine readable medium comprising instructions that when executed cause at least one processor to:
receive a first user utterance after a wake-up word for an artificial intelligence (AI) assistant;
feed the first user utterance to a speaker consistency check module configured to perform a speaker verification and a check spoken speed and to an acoustic consistency check module configured to perform an audio energy check and a signal-to-noise ratio (SNR) estimation;
save first outputs from the speaker consistency check module and the acoustic consistency check module;
receive a second user utterance after the first user utterance within a selected period of time;
feed the second user utterance to the speaker consistency check module and the acoustic consistency check module;
provide the first outputs from the speaker consistency check module and the acoustic consistency check module and second outputs from the speaker consistency check module and the acoustic consistency check module to a results fusion module to generate a result; and
determine whether the second user utterance is intended for the AI assistant, based at least in part on the result from the result fusion module.

16. The non-transitory machine readable medium of claim 15, further comprising additional instructions that when executed cause the at least one processor to:
provide the second user utterance to a large language model (LLM) for the AI assistant, based on the result.

17. The non-transitory machine readable medium of claim 15, wherein the instructions that when executed cause the speaker consistency check module to check the spoken speed utilize an automatic speech recognition (ASR) transcript, a force alignment model, and a lexicon dictionary.

18. The non-transitory machine readable medium of claim 15, wherein the instructions that when executed cause the result fusion module to generate the result cause the result fusion module to automatically assign weights to the speaker consistency check module and the acoustic consistency check module.

19. The non-transitory machine readable medium of claim 15, wherein the instructions that when executed cause the speaker consistency check module to check the spoken speed cause the speaker consistency check module to check spoken speed using a phonemes-based spoken speed calculation.

20. The non-transitory machine readable medium of claim 19, wherein the phonemes-based spoken speed calculation utilizes:
an automatic speech recognition (ASR) model to obtain a word level transcript,
a lexicon dictionary to convert the word level transcript to phonemes,
a force alignment model to obtain an actual user speech duration, and
calculate a spoken speed in phonemes per minute.
